(19) United States
(12) Patent Application Publication
(10) Pub. No.: US 2017/0072994 A1
(43) Pub. Date: Mar. 16, 2017

(54) APPARATUS AND METHOD FOR CONTROLLING ELECTRIC POWER STEERING SYSTEM

(71) Applicant: MANDO CORPORATION, Pyeongtaek-si (KR)

(72) Inventor: Seongjoo KIM, Seongnam-si (KR)

(21) Appl. No.: 14/852,625

(22) Filed: Sep. 14, 2015

(51) Int. Cl. B62D 5/04

(52) U.S. Cl. CPC B62D 5/0457; B62D 5/0463

(57) ABSTRACT

According to an embodiment of the present invention, an apparatus for controlling an electric power steering system includes a torque sensor detecting an amount of torque applied by a user and an amount of change in torque based on rotation of a handle; an electronic control unit calculating an assist current value based on the amount of torque and amount of change in torque; and a motor receiving the assist current value to assist in steering of a vehicle, wherein the electronic control unit divides a steering state of the vehicle into a plurality of regions based on the amount of torque and amount of change in torque and applies different assist current values to the motor in accordance with the divided regions.

### BACKGROUND

1. Field of the Invention

The present invention relates to an apparatus and method for controlling an electric power steering system, and more particularly, to an apparatus and method for controlling an electric power steering system capable of improving an awkward steering feeling of a driver caused by friction among several members constituting a steering system.

2. Discussion of Related Art

In general, a hydraulic steering system using hydraulic pressure of a hydraulic pump and an electric steering system using a motor are applied as steering systems in vehicles.

The hydraulic steering system consumes energy at all times regardless of a rotation of a steering wheel since the hydraulic pump, which is a power source supplying auxiliary steering power, is operated by an engine, whereas in the electric steering system, if a steering torque is generated by rotation of a steering wheel, auxiliary steering power proportionate to the steering torque is supplied to the motor.

The electric steering system is configured to have the auxiliary steering power transferred to a rack bar if the steering torque generated by the rotation of the steering wheel is transferred to the rack bar via a rack-pinion mechanism portion and the auxiliary steering power is generated in a steering motor based on the generated steering torque. That is, the steering torque generated by the steering wheel and the auxiliary steering power generated in the steering motor are combined to enable the rack bar to be moved in the axial direction.

Meanwhile, a steering angle and steering effort of the electric steering system are nonlinear due to frictional force among the members such as the rack-pinion mechanism, the rack bar, a decelerator, and the like. Particularly, a great steering effort is required when a driver begins to rotate wheels toward one side in a neutral steering state, and a smaller steering effort is required for a wider steering angle. Furthermore, steering characteristics in rotating the wheels toward one side and returning the wheels back to a neutral state become different, causing a driver to have an awkward steering feeling.

To solve this problem, reflecting a value obtained by multiplying an amount of change in a handle torque by a gain in accordance with velocity of a vehicle in an assist current value of a motor has been suggested. However, in this case, a greater noise is caused by an amount of change in noise if there is a noise component in a torque signal, and thus restriction on an amount of change or an amount of compensation is needed.

### SUMMARY OF THE INVENTION

According to an embodiment of the present invention, an object of an apparatus and method for controlling an electric power steering system is as follows.

The present invention is directed to providing an apparatus and method for controlling an electric power steering system capable of reducing an awkward steering feeling felt by a user by compensating friction among members of the electric power steering system.

The object of the present invention is not limited to that mentioned above, and other unmentioned objects will be clearly understood by those of ordinary skill in the art by descriptions below.

According to an embodiment of the present invention, there is provided an apparatus for controlling an electric power steering system, the apparatus including: a torque sensor detecting an amount of torque applied by a user and an amount of change in torque based on rotation of a handle; an electronic control unit calculating an assist current value based on the amount of torque and amount of change in torque; and a motor receiving the assist current value to assist in steering of a vehicle, wherein the electronic control unit divides a steering state of the vehicle into a plurality of regions based on the amount of torque and amount of change in torque and applies different assist current values to the motor in accordance with the divided regions.

The electronic control unit may include a filter unit filtering a high frequency signal included in a signal received from the torque sensor; and an assist current value calculation unit calculating an assist current value based on the signal filtered by the filter unit.

The amount of torque may be divided into one section and the other section with respect to a neutral steering state, and the plurality of regions may include a first region having the amount of torque positioned at the one section and the amount of change in torque increasing toward the one section; a second region having the amount of torque positioned at the one section and the amount of change in torque increasing toward the other section; a third region having the amount of torque positioned at the other section and the amount of change in torque increasing toward the other section; and a fourth region having the amount of torque positioned at the other section and the amount of change in torque increasing toward the one section.

Assist current values applied to the motor from the first region and the third region may be set greater than assist current values applied from the second region and the fourth region.

Assist current values applied to the plurality of regions may be defined by a function or map having a steering angle as a variable, and the electronic control unit may include a storage unit in which the function or map is stored.

Each of the functions of the assist current values defined in the plurality of regions may be set different from each other.

According to an embodiment of the present invention, there is provided a method for controlling an electric power steering system, the method including: calculating an amount of torque and amount of change in torque; classifying a steering state of a vehicle into a plurality of regions based on the amount of torque and amount of change in torque; and applying different assist current values in accordance with the divided regions to a motor.

Before the calculating of the amount of torque and amount of change in torque, the method may further include filtering a high frequency signal included in a signal received from a torque sensor.

The amount of torque may be divided into one section and the other section with respect to a neutral steering state, and the plurality of regions may include a first region having the amount of torque positioned at the one section and the amount of change in torque increasing toward the one section; a second region having the amount of torque positioned at the one section and the amount of change in torque increasing toward the other section; a third region having the amount of torque positioned at the other section and the amount of change in torque increasing toward the other section; and a fourth region having the amount of torque positioned at the other section and the amount of change in torque increasing toward the one section.

In the applying of assist current values to the motor, assist current values applied to the motor from the first region and the third region may be set greater than assist current values applied from the second region and the fourth region.

Assist current values applied to the plurality of regions may be defined by a function or map having a steering angle as a variable.

Each of the functions of the assist current values defined in the plurality of regions may be set different from each other.

According to an embodiment of the present invention, the apparatus and method for controlling an electric power steering system divide a steering state of a vehicle into a plurality of regions based on an amount of torque and amount of change in torque and apply different assist current values in accordance with the divided regions to a motor, thereby reducing an awkward steering feeling of a driver by compensating friction generated by parts constituting the electric power steering system.

The advantages of the present invention are not limited to those mentioned above, and other unmentioned advantages will be clearly understood by those of ordinary skill in the art by descriptions below.

### BRIEF DESCRIPTION OF THE DRAWINGS

FIG. 1 is a block diagram of an apparatus for controlling an electric power steering system according to an embodiment of the present invention;

FIG. 2 and FIG. 3 are graphs illustrating a correlation between a steering angle and steering effort of an apparatus for controlling an electric power steering system according to an embodiment of the present invention; and

FIG. 4 and FIG. 5 are flow charts sequentially illustrating a method for controlling an electric power steering system according to an embodiment of the present invention.

### DETAILED DESCRIPTION OF EXEMPLARY EMBODIMENTS

Exemplary embodiments of the present invention will be described in detail below with reference to the accompanying drawings while like reference numerals will be given to like or similar elements regardless of symbols in the drawings and repeated explanation thereof will be omitted.

In addition, if a detailed description of the known art related to the present invention is deemed to make the gist of the present invention vague, the detailed description thereof will be omitted. In addition, the accompanying drawings are only intended to make the spirit of the present invention easier to understand, and the spirit of the present invention should not be construed as being limited by the accompanying drawings.

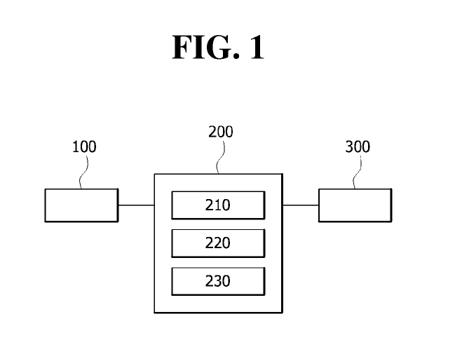

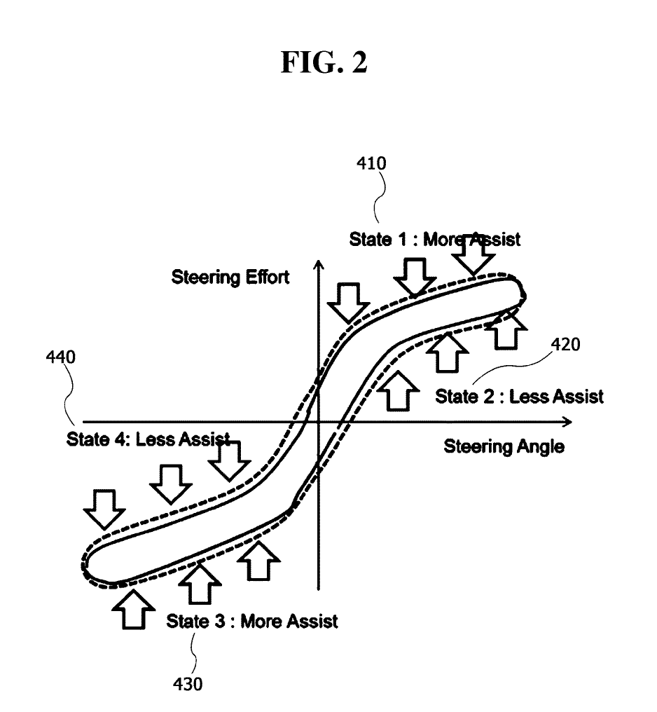

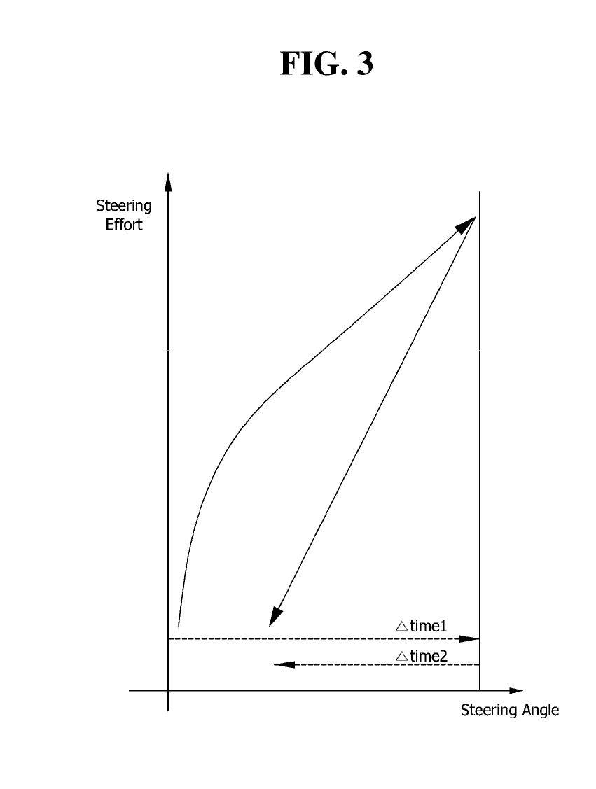

Hereinafter, an apparatus for controlling an electric power steering system according to an embodiment of the present invention will be described with reference to FIGS. 1 to 3. FIG. 1 is a block diagram of an apparatus for controlling an electric power steering system according to an embodiment of the present invention, and FIG. 2 and FIG. 3 are graphs illustrating a correlation between a steering angle and steering effort of an apparatus for controlling an electric power steering system according to an embodiment of the present invention.

As depicted in FIG. 1, the apparatus for controlling an electric steering system according to an embodiment of the present invention mainly includes a torque sensor 100, an electronic control unit 200, and a motor 300.

The torque sensor 100 performs a function of detecting an amount of torque applied by a user and an amount of change in torque based on rotation of a handle. Specifically, a torsion amount of a torsion bar positioned between an input shaft and an output shaft connected to a steering wheel is detected to output information on torque of the steering wheel.

The electronic control unit 200 receives the torque information outputted from the torque sensor 100, and performs a function of calculating an assist current value applied to the motor 300 based on the torque information. Specifically, as depicted in FIG. 1, the electronic control unit 200 may include a filter unit 210, an assist current value calculation unit 220, and a storage unit 230.

The filter unit 210 performs a function of filtering a high frequency signal included in a signal outputted from the torque sensor 100. That is, the filter unit 210 removes a noise signal generated by simple vibration etc. of the torque information detected by the torque sensor 100, thereby enabling the assist current value calculation unit 220 included in the electronic control unit 200 to calculate an assist current value applied to the motor 300 only with an amount of torque generated by a steering will of a driver and an amount of change in torque.

Meanwhile, as stated above, due to friction of several members such as a rack-pinion mechanism, a rack bar, and a decelerator constituting an electric power steering system, the correlation between a steering angle and steering effort of an apparatus for controlling an electric power steering system is shown by a hysteresis loop, as in FIG. 2. In other words, a greater steering effort is required when beginning steering toward one direction from an initial neutral steering position, and the steering effort tends to reduce as the steering angle becomes wider. On the other hand, the steering effort is reduced as in FIG. 2 when returning back to a neutral state while already in a steering state toward one direction. If friction of a mechanism portion is great, the difference of steering effort when steering and returning increases, causing a driver to feel a nonlinear steering feeling, which is a main complaint of customers.

To solve this problem, the apparatus for controlling an electric power steering system according to an embodiment of the present invention divides a steering state of a vehicle into a plurality of regions based on an amount of torque and amount of change in torque, and applies different assist current values in accordance with the divided regions to a motor. The steering state of a vehicle can be divided into four regions on the premise that the amount of torque is divided into one section and the other section with respect to a neutral steering state. Hereinafter, the divided regions in accordance with the steering state of a vehicle and setting assist current values according to the regions will be described in detail with reference to FIG. 2.

In the graph in FIG. 2, an x-axis is a steering angle, and a y-axis is a steering effort applied by a driver when steering in a corresponding steering angle. Hereinafter, descriptions will be given on the premise that a right region with respect to the y-axis is a case of steering to the right, and a left region is a case of steering to the left.

As stated above, the steering state of a vehicle is divided into four regions with respect to an amount of steering and an amount of change in steering. Specifically, as depicted in FIG. 2, the regions include a first region 410 having an amount of change in torque increasing toward the right while steering toward the right, a second region 420 having an amount of change in torque increasing toward the left even if steering toward the right, a third region 430 having an amount of change in torque increasing toward the left while steering toward the left, and a fourth region 440 having an amount of change in torque increasing toward the right even if steering toward the left.

In other words, the first region 410 and the third region 430 are states of steering toward the right or left due to a steering effort applied by a driver while in a neutral steering state of a vehicle, and the second region 420 and the fourth region 440 are states of returning back to the neutral steering state while steering toward the right or left. To mitigate heterogeneous steering characteristics between the first region 410 and the third region 430 and the second region 420 and the fourth region 440, in case of the first region 410 and the third region 430, it is preferable that a great assist current value is set to be applied to the motor 300, thereby improving a friction reduction effect. Furthermore, in case of the second region 420 and the fourth region 440, a small assist current value is set to be applied to the motor 300, thereby improving a restoration effect by tires. This will reduce a sense of difference between a steering effort when steering toward one or the other direction while in a neutral state and a steering effort when returning back to the neutral state while in a steering state.

Meanwhile, the assist current values applied to the plurality of regions can be defined by a function or friction compensation map having a steering angle as a variable. For this, it is preferable that the electronic control unit 200 include the storage unit 230 in which the function or map is stored.

In addition, as in FIG. 2, even if it is possible to apply the same assist current value to the first region 410 and the third region 430 or to the second region 420 and the fourth region 440, applying different assist current values to the first region 410 and the third region 430 or to the second region 420 and the fourth region 440 is also possible. That is, setting different assist current values not only in accordance with the amount of change in steering but also in accordance with a steering direction is possible. Specifically, functions of the assist current values defined in each of the regions may be set differently, thereby easily compensating the left/right difference in steering effort of a system.

FIG. 3 is one example realizing the above. By setting a time (Δtime1) proceeding from a steering direction greater than a returning time (Δtime2), the assist amount when steering can be greater than the assist amount when returning. Consequently, as in FIG. 2, a hysteresis loop becomes narrow. By realizing this characteristic by a map, different features for each region can be created.

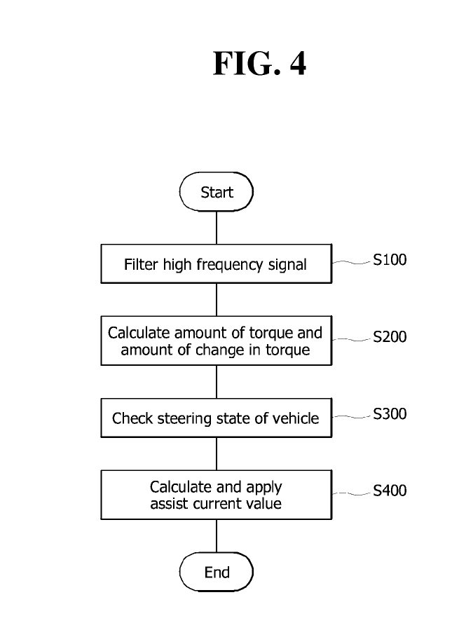

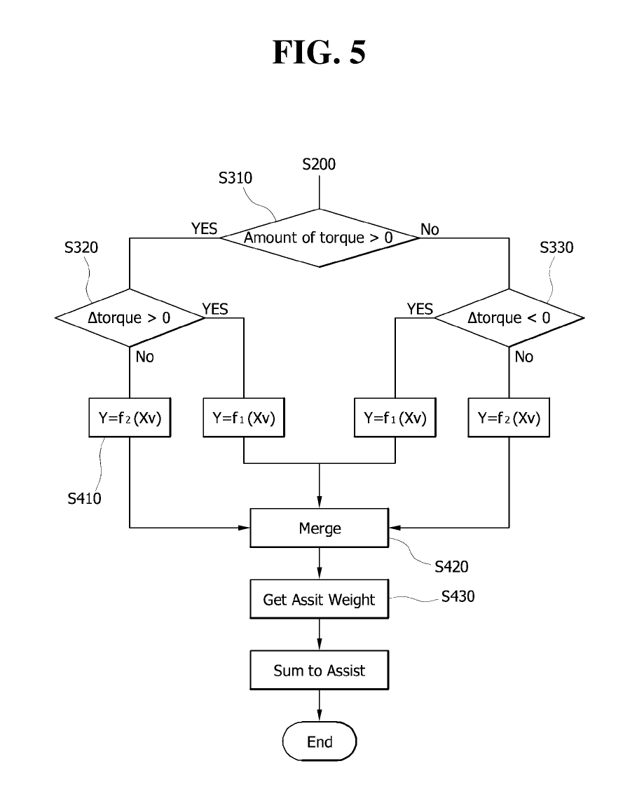

Hereinafter, a method for controlling an electric power steering system according to an embodiment of the present invention will be described with reference to FIG. 4 and FIG. 5 while detailed description of parts overlapping with the apparatus for controlling an electric power steering system according an embodiment of the present invention will be omitted. FIG. 4 and FIG. 5 are flow charts sequentially illustrating a method for controlling an electric power steering system according to an embodiment of the present invention.

According to an embodiment of the present invention, as depicted in FIG. 4, a method for controlling an electric power steering system includes calculating an amount of torque and amount of change in torque (S200); dividing a steering state of a vehicle into a plurality of regions based on the amount of torque and amount of change in torque (S300); and applying different assist current values in accordance with the divided regions to a motor (S400).

The electronic control unit 200 calculates the amount of torque and amount of change in torque based on a torque signal received from the torque sensor 100, wherein it is preferable that a high frequency region be removed. Accordingly, it is preferable that filtering a high frequency signal included in a signal received from the torque sensor 100 (S100) be performed prior to calculating the amount of torque and amount of change in torque (S200).

Meanwhile, in the dividing of the steering state of a vehicle into a plurality of regions (S300), after classifying the amount of torque into one section and the other section with respect to a neutral steering state, the steering state of a vehicle may be divided into a first region 410 having the amount of torque positioned at the one section and the amount of change in torque increasing toward the one section; a second region 420 having the amount of torque positioned at the one section and the amount of change in torque increasing toward the other section; a third region 430 having the amount of torque positioned at the other section and the amount of change in torque increasing toward the other section; and a fourth region 440 having the amount of torque positioned at the other section and the amount of change in torque increasing toward the one section. On the premise that the regions are divided in accordance with the steering state of a vehicle as above, it is preferable that the assist current values applied to the motor 300 from the first region 410 and the third region 430 are set greater than the assist current values applied from the second region 420 and the fourth region 440, and the detailed description thereof will be omitted since the description related thereto was provided in describing the apparatus for controlling an electric power steering system according to an embodiment of the present invention.

Meanwhile, the assist current values applied to the regions may be defined by a function or map having a steering angle as a variable. Hereinafter, detailed description on one example of classifying a steering state of a vehicle into a plurality of regions (S300) and calculating and applying assist current values based on the regions (S400) will be given with reference to FIG. 5.

In case of the amount of torque written in FIG. 5, if it is described on the premise that the amount of torque generated toward the right is a positive value and the amount of torque generated toward the left is a negative value, the electronic control unit 200 first checks whether the amount of torque is greater than 0, i.e. a direction in which steering is performed by steering effort applied by a driver in a neutral steering state of a vehicle (S310). Then, checking the amount of change in torque (Δtorque) while in a steering state toward one or the other direction (S320, S330) is performed. Throughout the steps, the steering state of a vehicle is divided into a total of four regions from the first region 410 to the fourth region 440.

As stated above, the assist current values applied to the plurality of regions can be defined by a function or map having a steering angle (Xv) as a variable. In case of an embodiment in FIG. 5, a function (Y=f1 (Xv)) applied to the first region and the third region and a function (Y=f2 (Xv)) applied to the second region and the fourth region are set differently. It is preferable that the assist current values resulting from the function applied to the first region and the third region be set to generate greater current than the assist current values resulting from the function applied to the second region and the fourth region.

Furthermore, in FIG. 5, even though functions of the first region and the third region and functions of the second region and the fourth region are uniformly set, it is possible to set functions of assist current values defined in all regions differently. By this, the left and right difference of steering force can be easily compensated, and a hysteresis loop can be freely changed.

If an assist current value for each region is calculated based on functions respectively defined in accordance with each region, merging the assist current values (S420) and calculating an overall weighted value of an assist current value (S430) are performed, thereby finally calculating an assist current value.

The embodiments described in this specification and the attached drawings merely serve to illustratively describe a part of the technical spirit included in the present invention. Accordingly, the embodiments disclosed in this specification are not for limiting the technical spirit of the present invention but for describing the same, and thus it is evident that the scope of the technical spirit of the present invention is not limited by the embodiments. Modifications and specific embodiments that can be easily made by those of ordinary skill in the art within the scope of the technical spirit included in the specification and the drawings of the present invention should all be construed as belonging to the scope of the present invention.

What is claimed is:

1. An apparatus for controlling an electric power steering system, the apparatus comprising:
a torque sensor detecting an amount of torque applied by a user and an amount of change in torque based on rotation of a handle;
an electronic control unit calculating an assist current value based on the amount of torque and amount of change in torque; and
a motor receiving the assist current value to assist in steering of a vehicle,
wherein the electronic control unit divides a steering state of the vehicle into a plurality of regions based on the amount of torque and amount of change in torque and applies different assist current values to the motor in accordance with the divided regions.

2. The apparatus of claim 1, wherein the electronic control unit comprises:
a filter unit filtering a high frequency signal included in a signal received from the torque sensor; and
an assist current value calculation unit calculating an assist current value based on the signal filtered by the filter unit.

3. The apparatus of claim 1, wherein the amount of torque is divided into one section and the other section with respect to a neutral steering state, and
the plurality of regions comprise:
a first region having the amount of torque positioned at the one section and the amount of change in torque increasing toward the one section;
a second region having the amount of torque positioned at the one section and the amount of change in torque increasing toward the other section;
a third region having the amount of torque positioned at the other section and the amount of change in torque increasing toward the other section; and
a fourth region having the amount of torque positioned at the other section and the amount of change in torque increasing toward the one section.

4. The apparatus of claim 3, wherein assist current values applied to the motor from the first region and the third region are set greater than assist current values applied from the second region and the fourth region.

5. The apparatus of claim 3, wherein the assist current values applied to the plurality of regions are defined by a function or map having a steering angle as a variable, and
the electronic control unit comprises a storage unit in which the function or map is stored.

6. The apparatus of claim 5, wherein each of the functions of the assist current values defined in the plurality of regions are is set different from each other.

7. A method for controlling an electric power steering system, the method comprising:
calculating an amount of torque and amount of change in torque ;
dividing a steering state of a vehicle into a plurality of regions based on the amount of torque and amount of change in torque; and
applying different assist current values to a motor in accordance with the divided regions.

8. The method of claim 7, further comprising, before the calculating of the amount of torque and amount of change in torque, filtering a high frequency signal included in a signal received from a torque sensor.

9. The method of claim 7, wherein the amount of torque is divided into one section and the other section with respect to a neutral steering state, and
the plurality of regions comprise:
a first region having the amount of torque positioned at the one section and the amount of change in torque increasing toward the one section;
a second region having the amount of torque positioned at the one section and the amount of change in torque increasing toward the other section;
a third region having the amount of torque positioned at the other section and the amount of change in torque increasing toward the other section; and
a fourth region having the amount of torque positioned at the other section and the amount of change in torque increasing toward the one section.

10. The method of claim 9, wherein, in the applying of assist current values to the motor, assist current values applied to the motor from the first region and the third region are set greater than assist current values applied from the second region and the fourth region.

11. The method of claim 9, wherein assist current values applied to the plurality of regions are defined by a function or map having a steering angle as a variable.

12. The method of claim 11, wherein each of the functions of the assist current values defined in the plurality of regions is set different from each other.
